(19) United States
(12) Patent Application Publication
(10) Pub. No.: US 2025/0303371 A1
(43) Pub. Date: Oct. 2, 2025

(54) PASSIVE BLENDER

(71) Applicant: Greener Blue Limited, Hinckley Leicestershire (GB)

(72) Inventor: Kevin James MUGGLETON, Hinckley Leicestershire (GB)

(21) Appl. No.: 18/866,764

(22) PCT Filed: May 16, 2023
(86) PCT No.: PCT/GB2023/051275

§ 371 Date: Nov. 18, 2024

(30) Foreign Application Priority Data
May 18, 2022 (GB) 2207260.7

(51) Int. Cl. B01F 25/10; B01F 23/10; B01F 25/00; B01F 25/431; B01F 25/4314

(52) U.S. Cl. CPC B01F 25/102; B01F 23/10; B01F 25/4314; B01F 25/431971; B01F 2025/913; B01F 2025/918

(57) ABSTRACT

A passive blender for introducing a mixer gas into a grid gas pipeline. The blender has an input section extending from an input inlet from which grid gas enters the blender to an input outlet along a longitudinal axis of the blender, wherein the input section reduces in cross-section from the input inlet to the input outlet and the longitudinal axis of the blender. The blender also has a mixer extending from a mixer inlet to a mixer outlet along the longitudinal axis of the blender, wherein the mixer inlet is positioned immediately adjacent the input outlet. The blender also has an output section extending from an outlet inlet to an output outlet along the longitudinal axis of the blender, wherein the output inlet is positioned immediately adjacent the mixer outlet.

### FIELD OF INVENTION

The present invention relates to the transport of gas in pipelines and the mixing of other gases into that gas pipelines.

### BACKGROUND

Grid gas pipelines generally transport natural gas from a source to a user. For example, in the UK most domestic dwellings are connected to a mains gas supply and use that gas for heating, cooking, and hot water. However, for a variety of reasons including the climate emergency and dependence on undesirable regimes it is desirable to reduce the use of natural gas. One way of doing this is to blend generated hydrogen gas or other alternative gases, such as biomethane, into the natural gas supply. For example, in the UK it has been found that blending up to 20% hydrogen by volume into the grid natural gas could save approximately 6 million tonnes of CO2 emissions each year. This is because hydrogen can be generated at large-scales with relatively low carbon production. Within the scope of the present application gases that may be added to the main grid natural gas supply will be called mixer gases.

One technical issue with the use of mixer gases in grid gas pipelines is how the mixer gas can be introduced into a grid gas pipeline at the intended percentage proportion. In the UK, trials are being undertaken to assess the implications of blending 20% hydrogen with the grid gas. Optimising the input without exceeding the limit requires a suitable control system. An additional challenge is that the grid gas may have previously been blended with a lower percentage of mixer. Therefore a system that samples and analyses the blended gasses downstream of the mixer injection point is required. Additionally, the sampled gas blend needs to be fully mixed to ensure a representative sample is taken for analysis. The gasses may blend naturally given sufficient distance downstream before the sample is taken. This could present an issue with correcting this volume of incorrectly blended gasses that would now be flowing in the gas grid. Therefore a static blending device that provided a homogenous blend of the gasses within a short distance of the injection point would make it possible for a sample to be supplied to a fast acting analyser and a feedback signal to be fed to a flow regulator valve to control the mixer gas injection rate. This blending device would also need to allow the grid gas to pass with a low pressure drop as a drop in grid gas pressure could be detrimental to the gas grid operation. This innovation describes such a blending device.

A passive blender is disclosed in GB2550130. The passive blender of GB2250130 has gas inputs from a mixer gas and the gas grid and outputs a blended gas. The blender has and an internal flow path that is shaped and sized to provide entraining and mixing of the gases using an inspiration effect. This mixing is achieved passively, without the need for mechanical component and/or external control. This is particularly advantageous in that a mixer gas is blended with gas from a grid gas pipeline in a passive blender that is very simple, having no moving parts, and allows a blended gas output of improved suitable physical characteristics to be produced from a mixer gas.

### SUMMARY OF INVENTION

The present invention provides a passive blender for introducing a mixer gas into a grid gas pipeline comprising:
an input section extending from an input inlet from which grid gas enters the blender to an input outlet along a longitudinal axis of the blender;
a mixer extending from a mixer inlet to a mixer outlet along the longitudinal axis of the blender, wherein the mixer inlet is positioned immediately adjacent the input outlet;
an output section extending from an outlet inlet to an output outlet along the longitudinal axis of the blender, wherein the output inlet is positioned immediately adjacent the mixer outlet; characterised in that:
a plurality of mixer apertures are formed in the mixer for inputting the mixer gas into the blender the apertures each mixer aperture extending from an external side of the blender into the blender, wherein the mixer apertures are formed such that mixer gas inputting the blender enters in a blending direction that has a circumferential component relative to the longitudinal axis of the blender to thereby induce swirl of the mixer gas in the blender.

The present invention is advantageous in that it provides a simple and effective passive blender for introducing a mixer gas into a grid gas pipeline. In particular, in use the passive blender can be positioned in a grid gas pipeline with the grid gas entering the blender via input inlet and grid gas exiting the blender via the output outlet. Mixer gas, for example hydrogen and/or biomethane or any other suitable gas, is introduced and blended with the grid gas via the mixer apertures.

The mixing of the mixer gas in the blender is particularly effective due to the form of the mixer apertures. In particular they are formed such that mixer gas inputting the blender enters in a blending direction that induces vortex swirl of the mixer gas in the blender. This can be achieved in any manner apparent to the person skilled in the art. As will be readily appreciated it is advantageous that, in order to induce swirl of the mixer gas in the blender, the circumferential component of the blending direction of each aperture should be in the same direction about a circumference of the blender. What is meant by a circumferential direction is shown in the Figures and is discussed below.

In embodiments of the invention the input section may reduce in cross-sectional area from the input inlet to the input outlet along the longitudinal axis of the blender

The blender is passive in that it comprises no moving parts that are driven to operate either by a motor or by the flow of gas within the blender. The passive blender may be used with additional apparatus that act to mix the gases. These apparatus may comprise moving parts and may include compressors, or any other suitable apparatus.

The blender further facilitates the blending of the gas by input section reducing in cross-sectional area from the input inlet to the input outlet and the longitudinal axis of the blender. This acts to accelerate the gas through the blender enhancing the mixing of grid gas with the mixer gas.

The blending direction of an aperture of the present invention may be any direction that induces vortex swirl in the combined mixer and grid gas. Advantageously, the blending direction of an aperture has a circumferential component such that a circumferential angle (α) of the blending direction relative to a radius of the blender is at least 5°. In embodiments of the invention the circumferential angle (α) may be at least 10°, at least 15°, at least 20°, at least 25°, at least 30°, at least 35°, at least 45°, at least 50°, at least 55°, at least 60°, at least 70° or at least 80°.

In embodiments of the invention, the blending direction of each aperture may be substantially the same with respect to the circumferential direction of the blender. Alternatively, different apertures may have different blending directions, so long as the blending directions act together to induce a vortex swirl in the combined mixer and grid gas through the blender.

In embodiments of the invention the blending direction of an aperture may have longitudinal component in a direction towards the input inlet such that the mixer gas is input into the blender against a flow of grid gas through the blender. That is the mixer gas of an aperture may enter the blender in a direction opposing the flow of grid gas through the blender. This can act to better mix the mixer gas and the grid gas within the blender. In embodiments of the invention the blending direction of every aperture may comprise a longitudinal component in a direction towards the input inlet. In alternative embodiments only some of the apertures have a blending direction in a direction towards the input inlet.

An aperture have a blending direction with a longitudinal component such that such that longitudinal angle (β) of the blending direction relative to a radius of the blender is at least 5°. In embodiments of the invention the longitudinal angle (β) may be at least 10°, at least 15°, at least 20°, at least 25°, at least 30°, at least 35°, at least 45°, at least 50°, at least 55°, at least 60°, at least 70° or at least 80°.

The mixer of the present invention may comprise any suitable number of apertures. A mixer according to the present invention has at least two apertures but may have more than this. For example, a mixer may have at least four, at least six, at least eight, at least ten, or at least twelve apertures. The mixer may have an even number of apertures or an odd number of apertures.

In simple embodiments of the invention the mixer outlet may be a simple aperture, for example a cylindrical aperture that does not substantially affect the gas flow therethrough. However, in embodiments of the invention it may be advantageous that the mixer outlet is shaped to induce a vortex, or swirling, gas flow in the output section of the blender. This may be achieved in any manner apparent to the person skilled in the art. In embodiments of the invention the mixer outlet may comprise one or more helical channels in an inner wall of the mixer outlet to induce vortex gas flow in the output section. One, two, three, four or more helical channels may be provided. If helical channels are provided gas passing through the mixer outlet will follow the path of the helical channels thereby inducing vortex, or swirling, gas flow in the output section of the blender.

If one or more helical channels is provided in the mixer outlet it may be advantageous that the or each helical channel twists at least 5°, 10°, 15°, 20°, 25°, 30°, 35°, 40°, or 45° about the longitudinal axis of the blender.

Mixer gas may be provided to the apertures of the mixer in any appropriate manner. In embodiments of the invention there may be a plurality of pipes, each supplying the mixer gas to one or more of the apertures for entry into the blender. In embodiments of the invention it may be advantageous that the passive blender further comprises a mixer gas input pipe that extends completely around the mixer section of the blender and is connected to a mixer gas input. In this manner the mixer gas can be efficiently provided to the apertures without the need for individual pipelines. Rather a supply of mixer gas can be provided around the mixer of the blender and can enter the apertures of the blender via the mixer gas input pipe that completely surrounds the mixer.

In order to better mix the mixer gas and the grid gas it may be advantageous that the output section increases in cross-sectional area from the output inlet to the output outlet. This may be achieved by an increase in diameter from the output inlet to the output outlet or in any other suitable manner, for example a change of shape from the output inlet to the output outlet.

The blender of the present invention is preferably used with a grid gas pipeline. The present invention further provides a grid gas pipeline including a passive blender according to the present invention.

Features and advantages of the present invention will be apparent from the embodiment shown in the Figures and described below. Unless otherwise indicated by the claims or by context any feature of the embodiment of the embodiment may be included in any other embodiment of the invention

### DRAWINGS

FIG. 1 is a two-dimensional cross-section through a cylindrical body illustrating a mixing direction according to the present invention;

FIG. 2 is a second two-dimensional cross-section through a cylindrical body illustrating a mixing direction according to the present invention;

FIG. 3 is a cross-section of an embodiment of a passive blender according to the present invention;

FIG. 4 is shows details of a mixer of the passive blender of FIG. 3;

FIG. 5 is a cross-section of an output section and the mixer of the passive blender of FIG. 3;

FIG. 6 is a cross-section of the passive blender of FIG. 3 illustrating the input of mixer gas into the passive blender;

FIG. 7 is a cross-section of the passive blender of FIG. 3 illustrating the vortex effect of the mixer outlet; and

FIG. 8 is a cross-section of the passive blender of FIG. 3 illustrating the mixing effect of the outlet section.

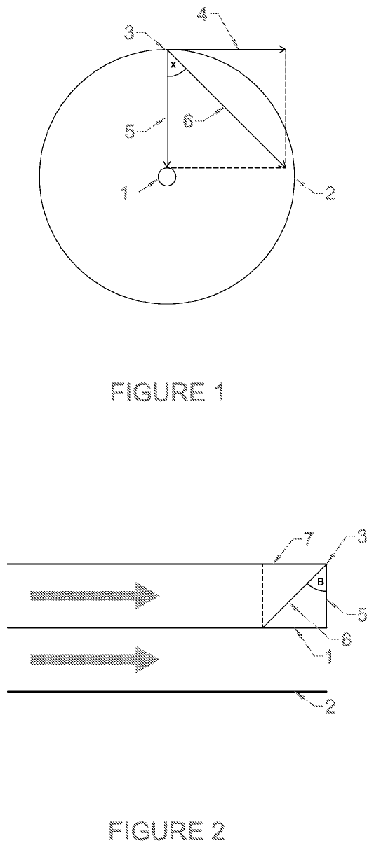

FIGS. 1 and 2 show two cross-sections through the same cylindrical body 2. FIG. 1 shows a cross-section perpendicular to a longitudinal axis 1 of the cylindrical body 2. FIG. 2 shows a cross-section parallel to the longitudinal axis of the cylindrical body 2. As set out above, the present invention defines that apertures 3 in the mixing section are formed mixing gas enters the mixing section in a blending direction 6 with a circumferential component 4. The meaning of this is made clear in FIGS. 1 and 2. An individual aperture 3 is shown in FIGS. 1 and 2 in relation to a cylindrical body. Mixing gas will exit the aperture in a blending direction 6.

The blending direction 6 can be defined as the sum of three linear components:
a circumferential component 4 in a direction parallel to the circumference of the cylindrical body 2 at the location of the aperture 3;
a radial component 5 in a radial direction towards the longitudinal axis 1 of the cylindrical body 2; and
a longitudinal component 7 in a direction parallel to the longitudinal axis 1 of the cylindrical body 2 in a direction opposing a flow of gas through the cylindrical body 2. Summing the circumferential component 4, the radial component 5 and the longitudinal component 7 gives the blending direction 6.

The blending direction 6 can also be defined as a vector with a magnitude and two angles:
a circumferential angle α of the blending direction 6 relative to a radius of the cylindrical body 2; and
a longitudinal angle β of the blending direction 6 relative to a radius of the cylindrical body 2.

The vector with the appropriate magnitude and angles α and β is the blending direction 6.

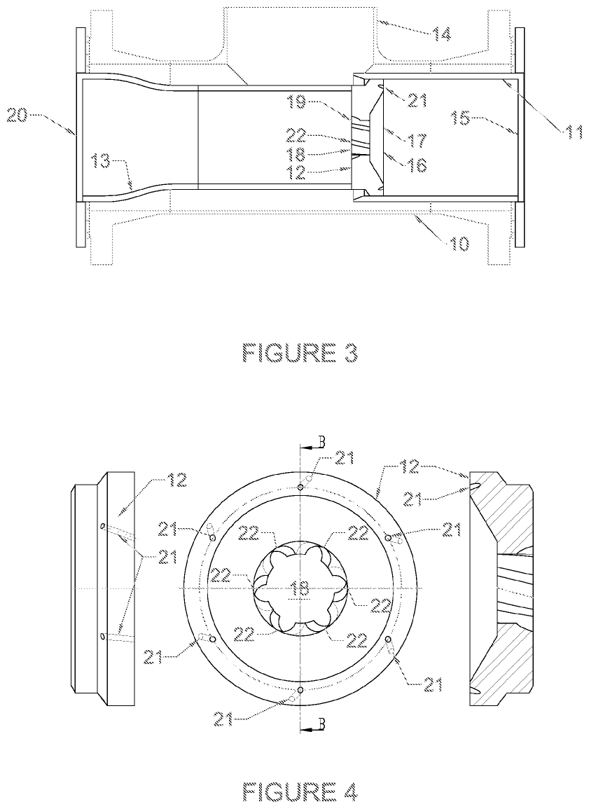

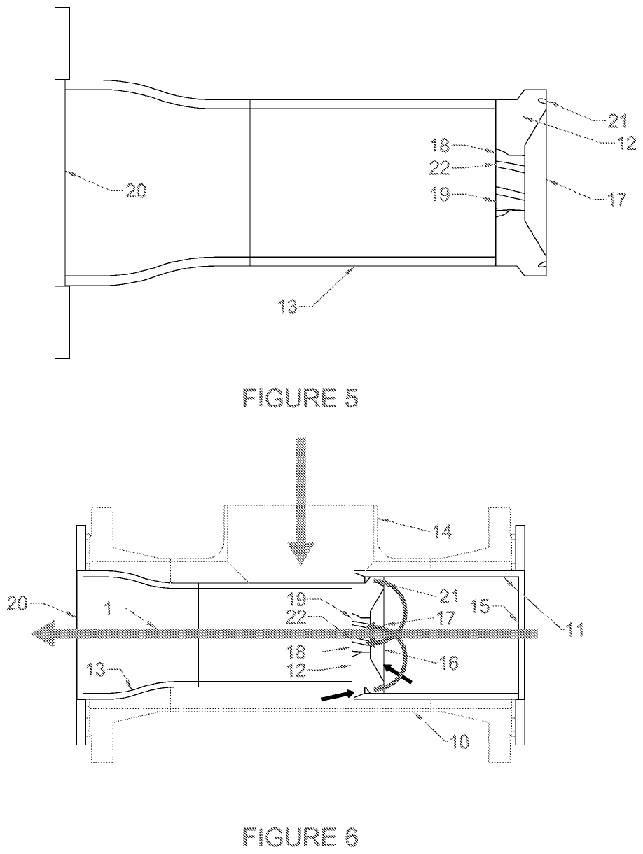

Details of a passive blender 10 according to the present invention are shown in FIGS. 3 to 8. The passive blender 10 is generally cylindrical and has a longitudinal axis 1. Therefore, the definitions of the blending direction 6 shown in FIGS. 1 and 2 and described above equally apply to the passive blender 10 of FIGS. 3 to 8.

The passive blender 10 comprises an input section 11, a mixer 12, an output section 13, and a mixer gas input pipe 14. The input section 11 extends from an input inlet 15 to an input outlet 16 along the longitudinal axis 1 of the passive blender 10. The mixer 12 extends from a mixer inlet 17 to a mixer outlet 18 along the longitudinal axis 1 of the passive blender 10. The output section 13 extending from an output inlet 19 to an output outlet 20 along the longitudinal axis 1 of the passive blender. The mixer 12 is fixed to the input section 11 and the output section 13 is fixed to the mixer 12 such that a gas path is formed through the passive blender 10 from the input inlet 15 to the output outlet 20. In use the input inlet 15 is fixed to a grid gas pipeline (not shown) and the output outlet 20 is fixed to a grid gas pipeline (not shown).

The input section 11 substantially consists of a length of pipeline that has a circular cross-section. The diameter of the input section 11 may decrease from the input inlet 15 to the input outlet 16 although the embodiment shown in the Figures has a constant cross-section. A decrease in cross-section acts to accelerate gas passing through the input section 11.

The output section 13 also substantially consists of a length of pipeline that a circular cross-section. As shown in FIGS. 6 to 8, the diameter of the output section can increase from the output inlet 19 to the output outlet 20 to better mix grid gas with a mixer gas. This is best shown in FIG. 8.

Details of the mixer 12 are shown in FIG. 4. The mixer has six apertures 21 formed in an outer part. The apertures 21 extend from an outer side of the mixer to the mixer inlet 17. The mixer outlet 18 is formed as a central aperture through the mixer 12. An inner diameter of the mixer 12 reduces from the mixer inlet 17 to the mixer outlet 18 such that gas passing through the mixer accelerates through the mixer outlet 18.

The mixer gas input pipe 14 extends from a mixer gas source (not shown), which might for example be a hydrogen gas source or a biomethane gas source, to completely surround the mixer 12 of the blender 10. This provides mixer gas from the mixer gas source to the apertures 21 of the mixer 12 for introduction into the blender 10.

The introduction of the mixer gas into the blender 10 is best illustrated in FIG. 6. The mixer gas enters the apertures 21 from the mixer gas input pipe 14. The mixer gas is then channelled through the apertures 21 into the blender adjacent the input outlet 16 and the mixer inlet 17. The shape of the apertures 21 means that the mixer gas inputs the blender 10 in a blending direction that has a longitudinal component 7 in a direction opposing the direction in which the grid gas passes through the blender 10. The shape of the apertures 21 also means that the mixer gas inputs the blender in a blending direction that has a circumferential component 4 that acts to swirl the mixer gas in the blender 10.

In the embodiment shown in the Figures the apertures 21 are straight and have a constant diameter. However, it will be understood that the apertures 21 can be curved, sinuate, have a varying or diameter, and/or have any shape that provides an appropriate blending direction of the mixer gas entering the blender 10.

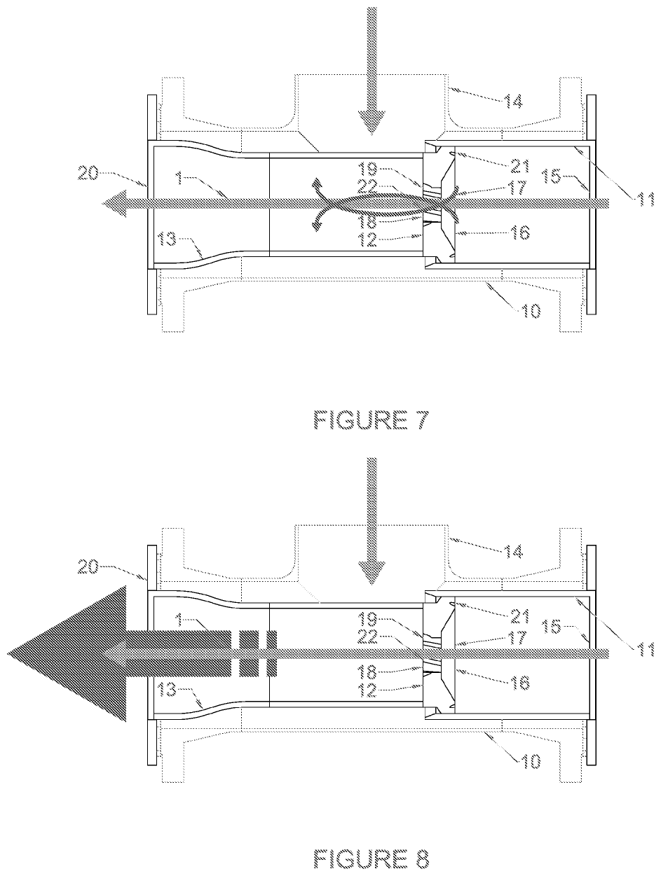

The mixer outlet 20 has six helical channels 22 formed along its length. These helical channels 22 act to create a vortex in the gas passing through the mixer outlet 20. This vortex is best shown in FIG. 7. The helical channels twist about 15° along the length of the mixer outlet 20. In the embodiment shown in the Figure a single helical channel 22 is provided for each aperture 21 but it is to be understood that this is not an essential feature of the invention, rather a different number of helical channels 22 to the number of apertures 21 can be provided. The helical channels 22 act to provide a vortex that spins the gas in the same direction as the mixing gas is spun by the circumferential direction of the blending direction provided by the apertures 21. This enhances mixing of the mixing gas with the grid gas.

1. A passive blender for introducing a mixer gas into a grid gas pipeline comprising:
an input section extending from an input inlet from which grid gas enters the blender to an input outlet along a longitudinal axis of the blender;
a mixer extending from a mixer inlet to a mixer outlet along the longitudinal axis of the blender,
wherein the mixer inlet is positioned immediately adjacent the input outlet;
an output section extending from an outlet inlet to an output outlet along the longitudinal axis of the blender, wherein the output inlet is positioned immediately adjacent the mixer outlet;
characterised in that:
a plurality of mixer apertures are formed in the mixer for inputting the mixer gas into the blender each mixer aperture extending from an external side of the blender into the blender, wherein the mixer apertures are formed such that mixer gas inputting the blender enters in a blending direction that has a circumferential component relative to the longitudinal axis of the blender to thereby induce vortex swirl of the mixer gas in the blender.

2. A passive blender according to claim 1, wherein the blending direction has a circumferential component such that a circumferential angle (α) of the blending direction relative to a radius of the blender is at least 5°.

3. A passive blender according to claim 1, wherein the blending direction has a longitudinal component in a direction towards the input inlet such that the mixer gas is input into the blender against a flow of grid gas through the blender.

4. A passive blender according to claim 3, wherein the blending direction has a longitudinal component such that a longitudinal angle (β) of the blending direction relative to a radius of the blender is at least 5°.

5. A passive blender according to claim 1, wherein the mixer comprises at least four mixer apertures.

6. A passive blender according to claim 5, wherein the mixer comprises at least eight mixer apertures.

7. A passive blender according to claim 2, wherein the mixer outlet is shaped to induce a vortex gas flow in the output section of the blender.

8. A passive blender according to claim 7, wherein the mixer outlet comprises helical channels in an inner wall of the mixer outlet to induce vortex gas flow in the output section.

9. A passive blender according to claim 8, wherein the helical channels twist at least 10° about the longitudinal axis of the blender.

10. A passive blender according to claim 1, further comprising a mixer gas input pipe that extends completely around the mixer section of the blender and is connected to a mixer gas input.

11. A passive blender according to claim 1, wherein the output section increase in diameter from the output inlet to the output outlet.

12. A grid gas pipeline including a passive blender according to claim 1.
